(19) United States
(12) Patent Application Publication
(10) Pub. No.: US 2014/0001862 A1
(43) Pub. Date: Jan. 2, 2014

(54) UNINTERRUPTIBLE POWER SUPPLY

(71) Applicants: HSIAO-PING HSUEH, Tu-Cheng (TW); YU-CHI TSAI, Tu-Cheng (TW)

(72) Inventors: HSIAO-PING HSUEH, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 13/562,391

(22) Filed: Jul. 31, 2012

(30) Foreign Application Priority Data
Jun. 29, 2012 (TW) 101123428

(51) Int. Cl. H02J 9/00

(52) U.S. Cl. 307/66

(57) ABSTRACT

An uninterruptible power supply (UPS) includes an alternating current (AC) power interface connected to an AC power source, a rectifier converting an AC voltage received from the AC power supply to a rectified direct current (DC) voltage, a converter converting the rectified DC voltage to a working DC voltage according to voltage requirement of the PSU of the electronic device, a charge and discharge circuit connected to the converter, a battery charged by the charge and discharge circuit, and a power distribution unit (PDU) to output the working DC voltage to the PSU. When the AC power source is down, the battery supplies power to the PDU through the charge and discharging circuit. The PDU further outputs the power from the battery to the PSU.

### CROSS-REFERENCE OF RELATED ART

Relevant subject matter is disclosed in pending U.S. patent applications with application Ser. No. 13/428,014, filed on Mar. 23, 2012, and application Ser. No. 13/439,919, filed on Apr. 5, 2012, with the same titles “UNINTERRUPTIBLE POWER SUPPLY”, which are assigned to the same assignee as this patent application.

### BACKGROUND

1. Technical Field

The present disclosure relates to an uninterruptible power supply.

2. Description of Related Art

An uninterruptible power supply (UPS) may be placed outside a server cabinet, to provide power to the server cabinet when the alternating current (AC) power source is down. The UPS includes a main AC power source and an auxiliary power source, such as a battery. The main AC power source provides an AC voltage to the server cabinet and also provides a direct current (DC) voltage to charge the battery by means of a converter, which includes a buck circuit and a feedback circuit for converting the AC voltage to the DC voltage. When the main AC power source is down, the UPS switches from the main AC power source to the battery, to provide an AC voltage to the server cabinet through an inverter, which converts the DC voltage output from the battery to an AC voltage. However, the converter and the inverter of the UPS will add cost and energy consumption of the UPS. Therefore, there is room for improvement in the art.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a block diagram of an uninterruptible power supply (UPS) in accordance with an exemplary embodiment of the present disclosure, wherein the UPS includes a converter, and a charge and discharge circuit.

FIG. 2 is a circuit diagram of the converter and the charge and discharge circuit of the UPS of FIG. 1.

### DETAILED DESCRIPTION

The disclosure, including the drawings, is illustrated by way of example and not by way of limitation. References to “an” or “one” embodiment in this disclosure are not necessarily to the same embodiment, and such references mean “at least one”.

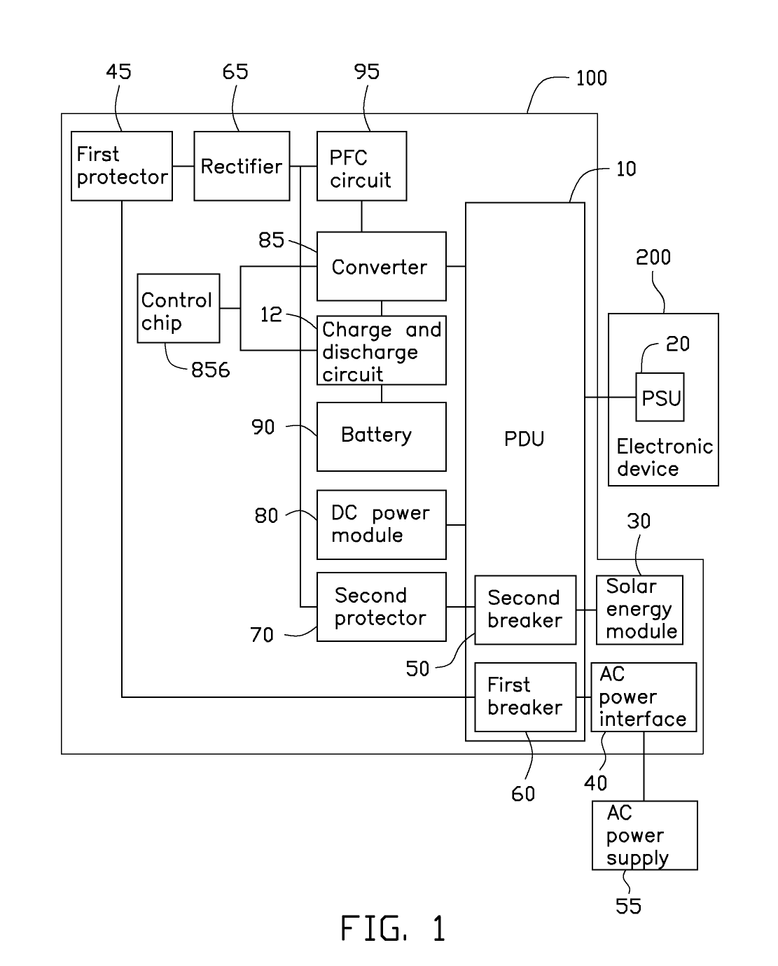

Referring to FIG. 1, an uninterruptible power supply (UPS) 100 provides power to a power supply unit (PSU) 20 of an electronic device 200. The UPS 100 in accordance with an exemplary embodiment includes an alternating current (AC) power interface 40, a solar energy module 30, a battery 90, a direct current (DC) power module 80, first and second protectors 45 and 70, a rectifier 65, a power factor correction (PFC) circuit 95, a converter 85, a power distribution unit (PDU) 10, and a charge and discharge circuit 12. The PDU 10 includes first and second breakers 60 and 50. The solar energy module 30, the battery 90, and the DC power module 80 are the auxiliary power sources of the UPS 100.

The AC power interface 40 is connected to an AC power supply 55 for receiving AC power. The AC power interface 40 is further connected to a first input terminal of the PDU 10 through the first breaker 60, the first protector 45, the rectifier 65, the PFC circuit 95, and the converter 85 in series. The solar energy module 30 is connected to a node between the rectifier 65 and the PFC circuit 95 through the second breaker 50 and the second protector 70 in series. The battery 90 is connected to the first input terminal of the PDU 10 through the charge and discharge circuit 12 and the converter 85 in series. The DC power module 80 is connected to a second input terminal of the PDU 10. An output terminal of the PDU 10 is connected to the PSU 20.

In one embodiment, the first and second breakers 50 and 60 are used for over-current protection. The first and second protectors 45 and 70 are electromagnetic relays. When an inrush current or a spike voltage of the UPS 100 occurs, the protectors 45 and 70 cut off to protect the UPS 100.

The rectifier 65 receives AC power from the AC power source 40 and converts the AC to DC, and outputs the DC voltage to the PFC circuit 95. The PFC circuit 95 receives the DC voltage from the rectifier 65 and regulates a power factor of the DC voltage, and outputs a regulated DC voltage to the converter 85. The converter 85 converts the regulated DC voltage to a working DC voltage, which accords with a voltage requirement of the PSU 20, and outputs the working DC voltage to the PSU 20 through the PDU 10.

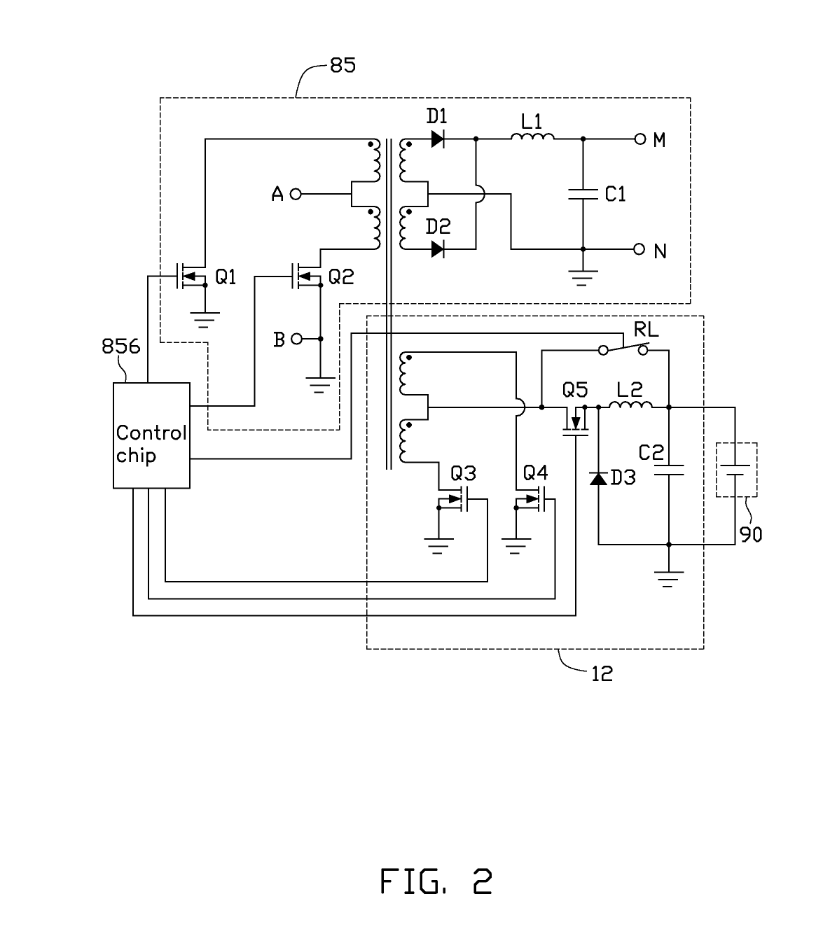

Referring to FIG. 2, the converter 85 includes a capacitor C1, an inductor L1, two diodes D1 and D2, two field effect transistors (FETs) Q1 and Q2, a transformer T, two voltage input terminals A and B connected to the PFC circuit 95, and two voltage output terminals M and N connected to the first input terminal of the PDU 10. A middle of a primary coil of the transformer T is connected to the voltage input terminal A. A drain of the FET Q1 is connected to a first end of the primary coil of the transformer T. A drain of the FET Q2 is connected to a second end of the primary coil of the transformer T. Sources of the FETs Q1 and Q2 are connected to the voltage input terminal B. The voltage input terminal B is grounded. Gates of the FETs Q1 and Q2 is connected to a control chip 856.

A first end of a first secondary coil of the transformer T is connected to an anode of the diode D1. A cathode of the diode D1 is connected to the voltage output terminal M through the inductor L1. A middle of the first secondary coil of the transformer T is connected to the voltage output terminal N. The capacitor C1 is connected between the voltage output terminals M and N. A second end of the first secondary coil of the transformer T is connected to an anode of the diode D1. A cathode of the diode D2 is connected to the cathode of the diode Dl. The voltage output terminal N is grounded.

The charge and discharge circuit 12 includes a switch RL, an inductor L2, a diode D3, a capacitor C2, FETs Q3, Q4, and Q5, and a second secondary coil of the transformer T. A drain of the FET Q4 is connected to a first end of the second secondary coil of the transformer T. A drain of the FET Q3 is connected to a second end of the second secondary coil of the transformer T. Sources of the FETs Q3 and Q4 are grounded. Gates of the FETs Q3 and Q4 are connected to the control chip 856. A middle of the second secondary coil of the transformer T is connected to a drain of the FET Q5. The middle of the second secondary coil is further connected to a first terminal of the switch RL. A source of the FET Q5 is connected to a first terminal of the inductor L2. A second terminal of the inductor L2 is connected to a second terminal of the switch RL. The source of the FET Q5 is further connected to a cathode of the diode D3. An anode of the diode D3 is grounded. The anode of the diode D3 is further connected to the second terminal of the inductor L2 through the capacitor C2. The battery 90 is connected in parallel with the capacitor C2. An anode of the battery 90 is connected to the second terminal of the inductor L2. A cathode of the battery 90 is grounded. A gate of the FET Q5 is connected to the control chip 856.

When the AC power supply 55 is working, the control chip 856 detects working status of the AC power supply 55, and corresponding controls the switch RL to be turned off, and the control chip 856 further outputs alternating low and high level signals sequentially to the gates of each of the FETs Q1 to Q5. Moreover, when the gate of the FET Q1 receives a high level signal, the gate of FET Q2 receives a low level signal. When the gate of the FET Q1 receives a low level signal, the gate of the FET Q2 receives a high level signal. When the gate of the FET Q3 receives a low level signal, the gate of the FET Q4 receives a high level signal. When the gate of the FET Q3 receives a high level signal, the gate of the FET Q4 receives a low level signal. The gate of the FET Q5 receives alternating low and high level signals.

When the FET Q1 is turned on, and the FET Q2 is turned off, the first end of the primary coil of the transformer T is grounded, and the middle of the primary coil of the transformer T is connected to the PFC circuit 95. The voltage output from the PFC circuit 95 is processed through the primary coil and the first secondary coil of the transformer T. The processed voltage is output to the PDU 10 through the two voltage output terminals M and N. Similarly, when the FET Q1 is turned off, and the FET Q2 is turned on, the second end of the primary coil of the transformer T is grounded, and the middle of the primary coil of the transformer T is connected to the PFC circuit 95. The voltage output from the PFC circuit 95 is processed through the primary coil and the first secondary coil of the transformer T. The processed voltage is output to the PDU 10 through the two voltage output terminals M and N.

When the FET Q3 is turned on, and the FET Q4 is turned off, the second end of the second secondary coil of the transformer T is grounded, and the middle of the second secondary coil of the transformer T is connected to the drain of the FET Q5. The voltage output from the PFC circuit 95 is processed through the primary coil and the second secondary coil of the transformer T. The processed voltage is output to the FET Q5 through the second secondary coil of the transformer T. Similarly, when the FET Q3 is turned off, and the FET Q4 is turned on, then the first end of the second secondary coil of the transformer T is grounded, and the middle of the second secondary coil of the transformer T is connected to the drain of the FET Q5. The voltage output from the PFC circuit 95 is processed through the primary coil and the second secondary coil of the transformer T. The processed voltage is output to the FET Q5 through the second secondary coil of the transformer T. After this, when the FET Q5 is turned on, the battery 90 is charged through the inductor L2 and the FET Q5.

When the AC power supply 55 is down, the control chip 856 controls the switch RL to be turned on, and the control chip 856 further outputs only low level signals to the gates of the FETs Q1 and Q2, outputs low and high level signals alternately to the gates of each of the FETs Q3 and Q4, and outputs a low level signal only to the gate of FET Q5. Moreover, when the gate of the FET Q3 receives a low level signal, the gate of the FET Q4 receives a high level signal. When the gate of the FET Q3 receives a high level signal, the gate of the FET Q4 receives a low level signal.

In this condition, because the FET Q5 is turned off, and the switch RL is turned on, the voltage from the battery 90 is output to the second secondary coil of the transformer T through the switch RL. When the FET Q3 is turned on, and the FET Q4 is turned off, the second end of the second secondary coil of the transformer T is grounded. The voltage from the battery 90 is output to the PDU 10 through the second secondary coil, and the first secondary coil of the transformer T.

The solar energy module 30, the battery 90, and the DC power module 80 provide DC voltages to the PSU 20 through the PDU 10 when the AC power supply 55 is down. The solar energy module 30 receives ambient light and converts the ambient light to a first DC voltage, and outputs the first DC voltage to the PFC circuit 95. The PFC circuit 95 regulates the power factor of the first DC voltage and outputs the regulated voltage to the converter 85. The converter 85 converts the regulated voltage to a working voltage and outputs the working voltage to the PSU 20 through the PDU 10. The DC power module 80 and the battery 90 output DC voltages to the PSU 20 through the PDU 10.

When the AC power supply 55 is down, the solar energy module 30, the DC power module 80, and the battery 90 are auxiliary power sources for directly providing DC voltages to the PSU 20 through the PDU 10, which significantly improves the reliability of the UPS 100. At the same time, the converter 85 of the UPS 100 avoids using buck circuits and feedback circuits, and this saves cost and energy.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. An uninterruptible power supply (UPS) applicable to a power supply unit (PSU) of an electronic device, the UPS comprising:
an alternating current (AC) power interface connected to an AC power supply;
a rectifier converting an AC voltage received from the AC power supply and the AC power interface to a rectified direct current (DC) voltage;
a converter converting the rectified DC voltage to a working DC voltage according to voltage requirement of the PSU of the electronic device;
a charge and discharge circuit connected to the converter;
a battery, wherein the charge and discharge circuit is operable of charging the battery; and
a power distribution unit (PDU) operable of outputting the working DC voltage to the PSU;
wherein when the AC power source is down, the battery supplies power to the PDU through the charge and discharging circuit, the PDU further outputs the power from the battery to the PSU.

2. The UPS of claim 1, wherein the converter comprises a first capacitor, a first inductor, a first diode, a second diode, first and second field effect transistors (FETs), a transformer, first and second voltage input terminals connected to the PFC circuit, and first and second voltage output terminals connected to the first input terminal of the PDU; the first voltage input terminal is connected to a middle of a primary coil of the transformer, a drain of the first FET is connected to a first end of the primary coil of the transformer, a drain of the second FET is connected to a second end of the primary coil of the transformer, a source of the second FET and the second voltage input terminal are grounded, gates of the first and second FETs are connected to a control chip, a first end of a first secondary coil of the transformer is connected to an anode of the first diode, a cathode of the first diode is connected to the first voltage output terminal through the first inductor, a middle of the first secondary coil of the transformer is connected to the second voltage output terminal, the first capacitor is connected between the first and second voltage output terminals, a second end of the first secondary coil of the transformer is connected to an anode of the second diode, a cathode of the second diode is connected to a cathode of the first diode, the second voltage output terminal is further grounded; the charge and discharge circuit comprises a switch, a second inductor, a third diode, a second capacitor, third to fifth FETs, and a second secondary coil of the transformer, a drain of the fourth FET is connected to a first end of the second secondary coil of the transformer, a drain of the third FET is connected to a second end of the second secondary coil of the transformer, sources of the third and fourth FETs are connected to the control chip, a middle of the second secondary coil of the transformer is connected to a drain of the fifth FET, the middle of the second secondary coil of the transformer is further connected to a first terminal of the switch, a source of the fifth FET is connected to a first terminal of the second inductor, a second terminal of the second inductor is connected to a second terminal of the switch, the source of the fifth FET is further connected to a cathode of the third diode, an anode of the third diode is grounded, the anode of the third diode is further connected to the second terminal of the inductor through the second capacitor, the battery is connected to the second capacitor in parallel, an anode of the battery is connected to the second terminal of the second inductor, a cathode of the battery is grounded, a gate of the fifth FET is connected to the control chip.

3. The UPS of claim 1, wherein the PDU comprises a breaker for over-current protection, the breaker is connected between the AC power interface and the rectifier.

4. The UPS of claim 1, further comprising a protector for over-current and over-voltage protection, wherein the protector is connected between the breaker and the rectifier.

5. The UPS of claim 1, further comprising a DC power module connected to the PDU.

6. The UPS of claim 1, further comprising a power factor correction (PFC) circuit, wherein the PFC is connected between the rectifier and the converter.

7. The UPS of claim 6, further comprising a solar energy module connected to a node between the PFC circuit and the rectifier.
